(19) United States
(12) Patent Application Publication
(10) Pub. No.: US 2001/0043038 A1
(43) Pub. Date: Nov. 22, 2001

(54) Frame in cathode ray tube

(75) Inventor: Sung Dae Kim, Taegu-Kwangyokshi (KR)

Correspondence Address: FLESHNER & KIM, LLP, P. O. Box 221200, Chantilly, VA, 20153-1200, US

(73) Assignee: LG Electronics Inc.

(21) Appl. No.: 09/837,292

(22) Filed: Apr. 19, 2001

(30) Foreign Application Priority Data
May 16, 2000 (KR) 2000/26075

(51) Int. Cl. H01J 29/80

(52) U.S. Cl. 313/407

(57) ABSTRACT

Frame in a cathode ray tube, and more particularly, to a frame of a tension mask type assembly for supporting a shadow mask to apply tension thereto in a cathode ray tube.

The frame in a cathode ray tube includes a main frame for fixing a shadow mask, and a subframe for supporting the main frame, thereby supporting the shadow mask with a tension applied thereto, wherein the subframe has a protruded part toward the shadow mask for minimizing deformation of the main frame caused by the tension on the shadow mask, the subframe being in symmetry in left and right directions with respect to a center of the subframe.

### BACKGROUND OF THE INVENTION

1. Field of the Invention

The present invention relates to a frame in a cathode ray tube, and more particularly, to a frame of a tension mask type assembly for supporting a shadow mask to apply tension thereto in a cathode ray tube.

2. Background of the Related Art

The cathode ray tube is a major component for displaying a picture in a display, such as a TV receiver or a computer monitor. FIG. 1 illustrates a side view with a partial cut away view of a related art color cathode ray tube.

Referring to FIG. 1, there is a fluorescent material screen 3 having red, green, and blue fluorescent materials coated on an inside surface of the panel 1 fitted to a front face of the cathode ray tube, a funnel 2 at a rear of the panel 1 welded thereto, and an electron gun 8 in a rear end of the funnel 2. There is a shadow mask 4 fixed to a frame 5 near to the fluorescent material screen 3 inside of the panel 1 for selecting colors of electron beams emitted from the electron gun 8. Springs 6 are fitted to a sidewall of the panel 1 for fastening the frame 5 to the panel 1. There is an inner shield 7 fixed to one side of the frame 5 for shielding the cathode ray tube so that the cathode ray tube is less affected by external geomagnetism. FIG. 2 illustrates a section of a related art frame 5.

Referring to FIG. 2, the related art frame 5 is provided with a main frame 11 the shadow mask 5 is fixed thereto, and a subframe 10 for supporting the main frame 11. A main axis of the subframe 10 and a curvature thereof are defined as follows for representing a related art subframe structure. A part of the subframe 10 between points at which the subframe 10 come into contact with the main frame 11 is defined as the main axis 12 of the subframe. For describing a form of the subframe 10, an extent of an outward curve of the subframe 10 toward the main axis 12 of the subframe with reference to a position of the shadow mask 4, i.e., from an inside formed by the shadow mask 4 and the frame 5 to outward, is defined as a positive curvature +R, and opposite to this, an inward curve of the subframe 10 toward the inside formed by the shadow mask 4 and the frame 5 is defined as a negative curvature −R. The definition of curvature is also applicable to a rectangular structure, but the definition of curvature is mostly used for representing a direction of curve of the subframe 12. Most of the main axis 12 of the subframe is parallel to the shadow mask 4 on the whole, except both ends that are curved. That is, the main axis 12 of the related art subframe 10 has a structure that has no curvature.

However, the foregoing subframe has a problem in that a substantially high tension can not be applied to the shadow mask 4. That is, when a tension is applied to the shadow mask 4, if a deformation of the main frame 11 fixed to the subframe 10 toward the shadow mask 4 is too great, application of an adequate tension to the shadow mask 4 is difficult, which has been solved solely depending on an elastic deformation according to a modulus of elasticity, a property of a subframe material. However, the reduction of the deformation of the main frame 11 solely depending on the property of the material is limited by an increase of a size of the shadow mask 4. Meanwhile, since additional heat treatment of the subframe 10 or change of the material for enhancing a yielding strength or modulus of elasticity of the subframe 10 requires substantial cost, though the effect is not certain, the heat treatment or the change of material can not be a basic solution.

### SUMMARY OF THE INVENTION

Accordingly, the present invention is directed to a frame in a cathode ray tube that substantially obviates one or more of the problems due to limitations and disadvantages of the related art.

An object of the present invention is to provide a frame in a cathode ray tube, which can apply an adequate tension to a shadow mask without change of a material or additional heat treatment of a subframe.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the frame in a cathode ray tube includes a main frame for fixing a shadow mask, and a subframe for supporting the main frame, thereby supporting the shadow mask with a tension applied thereto, wherein the subframe has a protruded part toward the shadow mask for minimizing deformation of the main frame caused by the tension on the shadow mask.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a side view with a partial cut away view of a related art color cathode ray tube;

FIG. 2 illustrates a section of a related art frame shown in FIG. 1;

FIG. 3 illustrates a section of a frame in accordance with a first preferred embodiment of the present invention;

FIG. 4 illustrates a section of a frame in accordance with a second preferred embodiment of the present invention;

FIG. 5 illustrates a section of a frame in accordance with a third preferred embodiment of the present invention; and,

FIG. 6 illustrates a state of work of the frame of the present invention.

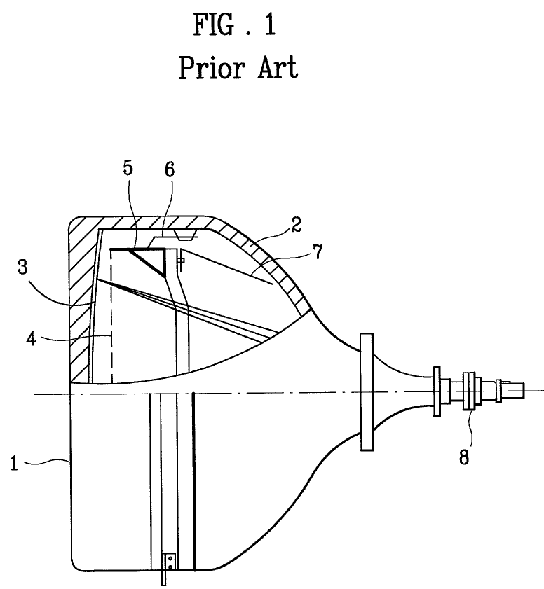

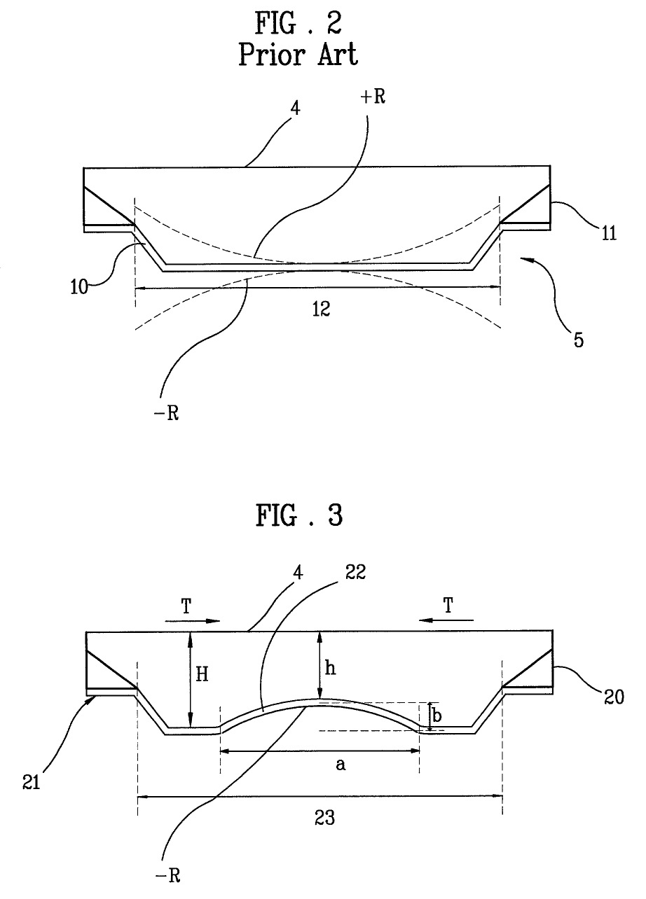

### DETAILED DESCRIPTION OF THE PREFERRED EMBODIMENT

Reference will now be made in detail to the preferred embodiments of the present invention, examples of which are illustrated in the accompanying drawings. FIG. 3 illustrates a section of a frame in accordance with a first preferred embodiment of the present invention.

Referring to FIG. 3, the frame in accordance with a first preferred embodiment of the present invention includes a protruded part 22 of a negative curvature -R according to the definition of a subframe curvature formed on a main axis 23 of the subframe which supports the main frame 20. The main frame 23 is a horizontal part of the related art subframe as defined before. The first embodiment frame of the present invention having the protruded part 22 is formed by curving the protruded part 22. The subframe 21 having the curved protruded part 22 is formed in symmetry in left and right directions such that deformation of the main frame fixed to both ends of the subframe 21 are the same. That is, the curved protruded part 22 is formed as the main axis 23 of the subframe itself is formed partly curved in symmetry in left and right directions to have a negative curvature such that the central portion appears similar to a convex lens laying faced upward, and in a horizontal direction from ends of the convex lens to sloped parts on both sides of the main axis 23 of the subframe. Or, different from this, the protruded part 22 is formed to start from parts the slopes are started on both sides of the main axis 23 of the subframe without providing the horizontal parts and to have a negative curvature −R in overall. The protruded part 22 shifts a center of the main axis 21 of the subframe toward the shadow mask 4, leading a gap H between the shadow mask 4 and the main frame 23 of the subframe to be reduced as much as a height ‘b’ of the protruded part 22. The gap ‘h’ between the shadow mask 4 and the center of main axis 21 of the subframe is defined as a moment length ‘h’. Then, a bending moment on a center of the main axis 23 of the subframe, i.e., a product of the tension ‘T’ to the shadow mask 4 and the moment length ‘h’, is smaller than a bending moment ‘T×H’ in the related art. The extent of curving of the protruded part 22 may be adjusted, to increase the height ‘b’ of the protruded part 22, to provide a variety of subframe 21 forms, for reducing the bending moment on the center of the main axis of the subframe. Nevertheless, overall forms of the protruded parts 22 are almost similar on the whole, except that the heights ‘b’ and the widths ‘a’ of the protruded parts 22 differ.

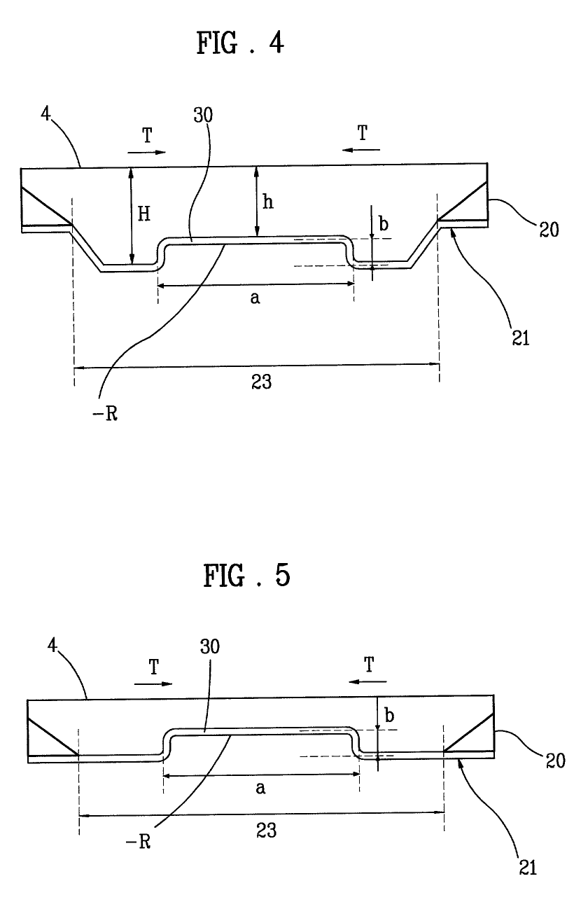

Referring to FIG. 4, different from the convex form of the protruded part 22, the protruded part 30 may be formed by bending the subframe 21 at desired angles. That is, the main axis 21 of the subframe is bent many times partly, to form the protruded part 30 having a surface parallel to the shadow mask 4. That is, a profile of the protruded part may be rectangular or trapezoidal with a negative curvature −R in symmetry in left and right directions so that deformation of the main frame 20 at both ends thereof fixed to the subframe 21 are the same. That is, the bent type protruded part 30 is formed as the main axis 23 of the subframe itself is bent for a plurality of times at desired angles in symmetry in left and right directions such that the main axis 23 of the subframe is formed to have a rectangular or trapezoidal profile at a central portion and to have horizontal portions from ends of the bent to sloped parts at both ends of the main axis of the subframe 21. Or, different from this, the protruded part 30 with a negative curvature −R in overall may be started from the sloped parts at both ends of the main axis of the subframe. The foregoing protruded part 30 shifts a center of the main axis 23 of the subframe toward the shadow mask 4, leading the gap ‘H’ between the shadow mask 4 and the main axis of the subframe to be reduced as much as a height ‘b’ of the protruded part 22. Then, alike the first embodiment, in this case too, a bending moment, a product of a tension ‘T’ to the shadow mask 4 and a moment length ‘h’, on a center of the main axis 23 of the shadow mask 4 is made smaller than a bending moment ‘T×H’ on the related art subframe. A variety of subframe 21 forms with the protruded parts 30 may be provided if the height ‘b’ of the protruded part 30 is made greater in an intention for reducing the bending moment on the center of the main axis 23 of the subframe. Still, an overall form of the protruded part 30 is almost similar, except that the height ‘b’ and a width ‘a’ of the protruded part 30 differ.

As shown in the foregoing embodiments, the reason that the protruded part 22 or 20 is formed to reduce a bending moment on the main axis of the subframe is for reducing deformation of the main frame 20 when a tension is applied to the main frame 20 that is fixed to the subframe 21. Modified versions of the first and second embodiments in which a plurality of the protruded part are formed for satisfying the above object will be explained.

Two curved protruded parts of the first embodiment may be formed on the subframe in symmetry in left and right directions, or one curved protruded part at a center and two curved protruded parts on left and right sides thereof may be formed. Or, two bent protruded parts of the second embodiment may be formed on the subframe in symmetry in left and right directions, or one bent protruded part at a center and two bent protruded parts on left and right sides thereof may be formed. The modified versions of the protruded part reduce deformation of the subframe along with deformation of the main frame. However, it is required that the modified versions of respective embodiments are applied selectively taking material of the frame and the tension required for the shadow mask into account, because provision of unreasonably many number of the protruded parts may makes a strength of the subframe poor, and fabrication of the subframe difficult.

In the meantime, another modified version of the first or second embodiment, which is a third embodiment of the present invention, that minimizes the deformation of the main frame, will be explained with reference to FIG. 5.

Referring to FIG. 5, the sloped parts of the subframe are not provided, to provide a flat subframe, and a protruded part 30 either of the first embodiment or the second embodiment is formed on the main axis of the subframe. Since the third embodiment subframe has the simplest structure compared to other embodiment structures, that has the most convenient fabrication process and a small deformation, a stress on points the protruded parts ends on the subframe can be substantially great. Therefore, though it is dangerous to apply unreasonably high tension to the shadow mask, a tension higher than the related art can be applied.

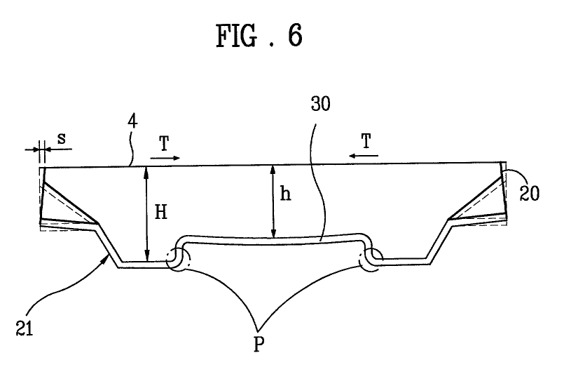

Since works of the foregoing frames in the embodiments of the present invention are almost same, the work of the frame of the present invention will be explained with reference to the second embodiment and FIG. 6.

While the related art subframe having no curvature, i.e., no protruded part, on the main axis of the subframe has a bending moment, a product of a tension ‘T’ and a moment gap ‘H’, exerting on a central portion thereof, the subframe of the present invention having the protruded part 30 with a negative curvature formed on the main axis 23 of the subframe has a bending moment, a product of the tension ‘T’ and the moment gap ‘h’, which is smaller than the same of the related art because of the reduced moment gap. Eventually, the main frame is involved in a deformation ‘S’ in a direction of tension smaller than the same of the related art main frame in a subframe 21 structure of the present invention. In detail, the smaller bending moment on the protruded part 30 with a negative curvature results in a smaller bending at a center of the subframe 21, and major bending at both points ‘P’ the protruded part 30 ends where the main axis of the subframe curves or bends, causing a bending ‘S’ of the main frame smaller than the same of the related art, that allows the frame to apply a greater tension to the shadow mask 4 as much as the reduction of deformation ‘S’ of the main frame 20.

As has been explained, the frame in a cathode ray tube of the present invention has the following advantages.

The smaller bending deformation of the subframe obtained by changing a structure of the subframe in the present invention permits application of a greater tension to the shadow mask, at the end. The greater tension to the shadow mask improves the problem of doming caused by mismatch between slots in the shadow mask and the electron beams coming from the thermal deformation of the shadow mask as well as the problem of howling, a vibration of the shadow mask caused by an external vibration or impact, as the greater tension increases a natural frequency of the shadow mask. The only change in a subframe structure while keeping a basic structure of the related art frame for providing the foregoing effect permits an easy application of the present invention to the present cathode ray tube for improving performance of the related art cathode ray tube at a low cost.

It will be apparent to those skilled in the art that various modifications and variations can be made in the frame in a cathode ray tube of the present invention without departing from the spirit or scope of the invention. Thus, it is intended that the present invention cover the modifications and variations of this invention provided they come within the scope of the appended claims and their equivalents.

What is claimed is:

1. A frame in a cathode ray tube, the frame comprising:
a main frame for fixing a shadow mask; and,
a subframe for supporting the main frame, thereby supporting the shadow mask with a tension applied thereto,
wherein the subframe has a protruded part toward the shadow mask for minimizing deformation of the main frame caused by the tension on the shadow mask, the subframe being in symmetry in left and right directions with respect to a center of the subframe.

2. A frame as claimed in claim 1, wherein the protruded part of the subframe is formed as the subframe itself is deformed into a curved form.

3. A frame as claimed in claim 2, wherein a plurality of the protruded parts are formed.

4. A frame as claimed in claim 1, wherein the protruded part of the subframe is formed to have a surface parallel to the shadow mask by bending the subframe itself many times.

5. A frame as claimed in claim 4, wherein a plurality of the protruded parts are formed.

6. A frame as claimed in claim 1, wherein the subframe is parallel to the shadow mask except the protruded part.
